(19) United States
(12) Patent Application Publication
(10) Pub. No.: US 2005/0228734 A1
(43) Pub. Date: Oct. 13, 2005

(54) Fixed income performance attribution

(76) Inventor: Giovanni Pagani, Novazzano (CH)

Correspondence Address: LESLIE GLADSTONE RESTAINO;BROWN RAYSMAN MILLSTEIN & STEINER LLP, 163 MADISON AVENUE, PO BOX 1989, MORRISTOWN, NJ, 07962-1989, US

(21) Appl. No.: 10/820,361

(22) Filed: Apr. 7, 2004

(51) Int. Cl. G06F 17/60

(52) U.S. Cl. 705/36

(57) ABSTRACT

Methods and corresponding systems are provided for attributing investment portfolio performance by identifying one or more fixed income securities that contributes to the performance of an investment portfolio, and decomposing the performance of the fixed income security into one or more components that correspond to the performance attributed to at least one investment strategy that contributes to the performance of the identified fixed income security.

### BACKGROUND OF THE INVENTION

The present invention generally relates to methods and systems for determining the performance of an investment portfolio. More particularly, the present invention provides methods and systems designed to decompose or separate the rate of return associated with an investment portfolio into components that correspond to particular investment strategies applied to the investment portfolio.

Fixed income asset managers can improve the performance or rate of return of a fixed income portfolio by applying a variety of different investment strategies, such as duration management, market allocation, sector rotation, currency allocation, etc. In global multi-sector bond portfolios, for instance, the rate of return may be improved with strategies directed to duration management, curve positioning, market allocation, sector allocation, security selection, currency allocation, etc. Identifying and quantifying the source of the performance is therefore an important indicator to assess the strengths and weaknesses of the investment process.

The performance of a fixed income portfolio, however, is usually managed with multiple coexisting and interrelated investment strategies, which makes the direct measurement of the performance of a particular investment strategy extremely difficult. The performance attributed to investment strategies has therefore been inferred from the portfolio's overall performance. One inference with regard to performance contribution has been to consider the performance of individual bonds, e.g., the hedged return of a specific bond, in relation to the overall performance of the investment portfolio. Individual bonds, however, are typically included in the investment portfolio based on or in accordance with more than one investment strategy, e.g., duration management, sector allocation, etc. The performance of individual bonds is therefore not an accurate measure of the performance attributed to particular investment strategies.

There is therefore a need for an attribution model that accurately reflects the contribution of particular investment strategies to the overall performance of the investment portfolio. There is further a corresponding need for methods and systems that decompose the performance of the investment portfolio, in accordance with an attribution model, that accurately compute or otherwise determine the performance attributed to particular investment strategies.

### SUMMARY OF THE INVENTION

The present invention generally provides methods and systems for attributing the contribution of investment strategies to the overall performance of an investment portfolio. In one aspect of the present invention, methods and systems for attributing investment portfolio performance are provided which include the steps of identifying at least one fixed income security that contributes to the performance of an investment portfolio, and decomposing the performance of the fixed income security of the investment portfolio into one or more components that correspond to the performance attributed to one or more investment strategies that contribute to the performance of the fixed income security identified.

It is understood that various types of strategies may be applied and thereby contribute to the performance of the fixed income security. In one embodiment, the performance is decomposed into at least one of a fixed income allocation component and a currency allocation component. The currency allocation component generally includes a return or returns attributed to strategies associated with currencies and the fixed income allocation component includes a return attributed to fixed income securities. It is further understood that the return may be defined in various ways. In one embodiment, the return is defined in terms of a hedged return, which accounts for forward premiums and the like, which are used to hedge the fixed income security or an aspect thereof.

In another embodiment, the performance of the fixed income security is further decomposed with regard to the fixed income component into at least one component that corresponds to an investment strategy associated with fixed income security asset management, such as a yield curve management strategy component, a sector allocation strategy component, and a security selection strategy component. In yet another embodiment, the fixed income component is decomposed into one of a duration allocation strategy component, a curve positioning strategy component, a market allocation component, a sector allocation strategy component, and a security selection strategy component.

In another embodiment, the fixed income allocation component is decomposed into at least one component that corresponds to a driver along which an investment strategy is set, e.g., a factor that drives the investment strategy. The investment strategy, for instance, may be driven by interest rate or yield changes, such as a duration allocation strategy, a curve positioning strategy, and a market allocation strategy.

In another aspect methods and systems are provided for attributing investment portfolio performance that include the steps of identifying one or more fixed income security that contributes to the performance of an investment portfolio, and decomposing the performance of the identified fixed income security into one ore more components that correspond to the performance attributed to one ore more investment strategies that contribute to the performance of the identified fixed income security. In this instance, the investment strategy is selected from a group consisting of a currency allocation component, a duration allocation strategy component, a curve positioning strategy component, a market allocation component, a sector allocation strategy component, and a security selection strategy component.

Additional aspects of the present invention will be apparent in view of the description which follows.

### BRIEF DESCRIPTION OF THE FIGURES

The invention is illustrated in the figures of the accompanying drawings, which are meant to be exemplary and not limiting, in which like references refer to like or corresponding parts, and in which:

FIG. 1 is a block diagram of an attribution model for decomposing the performance of an investment portfolio into components that correspond to the performance attributed to particular investment strategies applied to the investment portfolio according to one embodiment of the invention.

FIG. 2 is a block diagram of a computer system for decomposing the performance according to one embodiment of the invention.

### DETAILED DESCRIPTION OF PREFERRED EMBODIMENTS

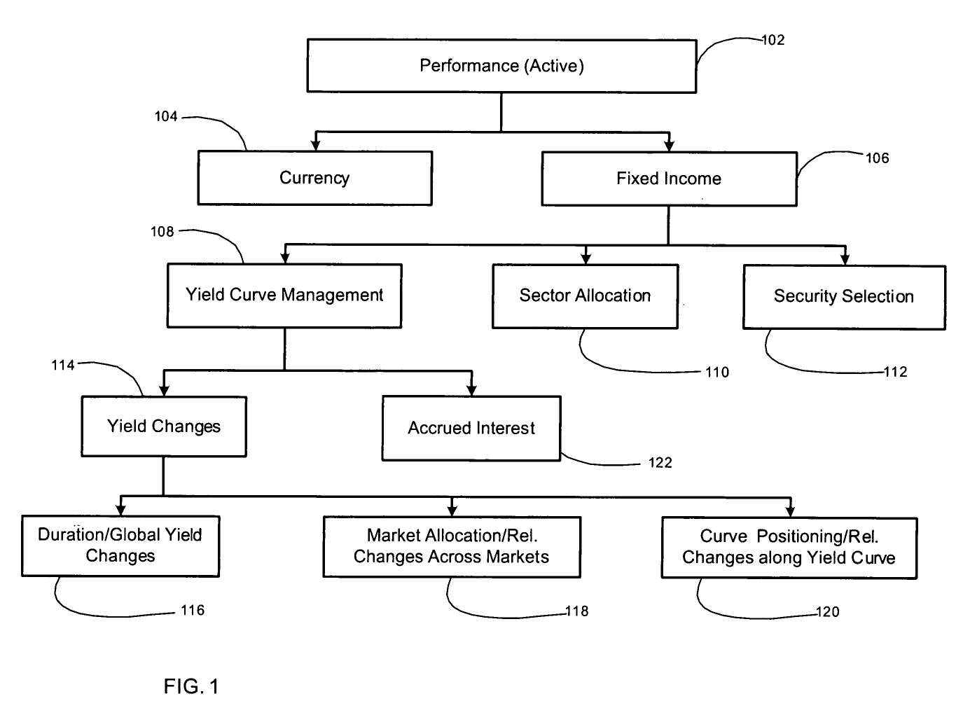

Referring to FIG. 1, an attribution model or methodology for decomposing the performance of an investment portfolio into components corresponding to the performance attributed to particular investment strategies, e.g., in a multiple currency and multiple sector global bond portfolio, according to one embodiment, first separates the performance 102, e.g., the active performance, of the portfolio into a currency allocation 104 and a fixed income allocation 106. Currency allocation 104 refers to the return attributed to strategies associated with the allocation to the different currencies through fixed income securities, such as bonds, money market instruments, etc. as well as currency instruments, such as currency forwards, futures etc. Although the present invention may be discussed by way of example in relation to particular types of investment portfolios, such as a multiple currency and sector global bond portfolio, it is understood that the present invention is equally applicable to other types of non-fixed income and fixed income portfolios, including multiple-market, single currency, sovereign portfolios, etc., and is therefore not limited thereto.

In this iteration of the attribution model, where performance can be attributed to currency 104 and fixed income 106 allocations, and where the currency return considers both the relative appreciation of the currencies and the interest rates differences across markets. An attribution model not considering the latter component allows for the construction of a risk free portfolio, e.g., with zero total performance with respect to currency and fixed income allocations 104, 106, that incorrectly shows the non-zero attribution of the portfolio's components.

For example, a portfolio may be constructed where the investor borrows USD 1,000,000 for 3 months at Libor rate 2% (USD 5,000 interest), exchanges the borrowed money spot in EUR at 1.000 USD/EUR, and lend 1,000,000 EUR at Libor 3% over the same 3 months period (EUR 7,500 proceeds). In order to hedge the currency exchange rate risk, the investor further sells EUR 1,007,500 into USD three months forward at 0.9975 USD/EUR. This amounts to USD 1,005,000, which covers the capital and interest pay back for the money borrowed. In this instance, the overall zero return decomposes into USD +2,500 for the fixed income allocation (net of EUR and USD interests cash flows), and USD −2,500 to the currency allocation (the EUR depreciates by 0.25% with respect to the USD in the forward market). The non-zero attributions therefore show a performance bias in favor of the fixed income allocation.

For an unbiased attribution, the forward currency market is considered. In the forward currency market, currencies can be exchanged at a premium or discount with respect to the spot exchange rates. An investor can buy a bond in a foreign market and sell the corresponding currency forward eliminating the exposure to the currency fluctuations, as shown in the above example. The corresponding currency hedged return will therefore depend only on the fixed income market. Therefore, the return of a bond issued in a foreign local market can be decomposed into a fixed income component, e.g., the hedge bond return (HBR), and a currency return (CR) component, as shown in the following algorithm:

$${BR}_{USD} = \underbrace{( {BR}_{LOC} \text{-} {f}_{LOC \text{-} USD} )}_{{hedged bond return}_{( HBR )} } + \underbrace{( {FX}_{USD \text{-} LOC} + {f}_{LOC \text{-} USD} )}_{{currency return}_{( CR )}}$$

Where:
BR_{USD}=bond return in USD
BR_{LOC}=local currency return of the bond
f_{LOC-USD}=forward premium between the local currency and the dollar
FX_{USD-LOC}=rate of change of the dollar exchange rate relative to the local currency

In this instance, the return attributed to the fixed income allocation is based on the bond return measured in the local currency adjusted by the forward premium, which, at the same time, is added to the foreign exchange movement to quantify the return attributed to the correct currency allocation. In the previous example, the lending return of EUR 7,500 would be adjusted to EUR 5,000 resulting in a zero performance attribution to both fixed income and currency allocations.

In an arbitrage free market, the forward premium or discount amounts to the term interest rate difference between the two markets. Therefore, the decomposition can alternatively be written as:

$${BR}_{USD} - {c}_{USD} = \underbrace{( {BR}_{LOC} - {c}_{LOC} )}_{bond risk premium} + \underbrace{( {FX}_{USD \text{-} LOC} + {c}_{LOC} - {c}_{USD} )}_{local cash}$$

Where:
C_{USD}=term interest rate in USD (“cash return”)
F_{LOC-USD}=C_{LOC}−C_{USD}

It can be seen that the excess return of bonds over cash in the reference currency involves two distinct decisions: the management of the bond excess returns over local cash and the cash management across currencies. This distinction is particularly important when the term interest rates vary significantly across markets. With respect to the example illustrated in Table A, the EUR Bond outperformed the JPY Bond in local terms by 1%, however; with the necessary adjustments for differences in term interest rates, the JPY outperformed the EUR bond by 2%.

TABLE A

| | Term interest | Local Currency | Bond Excess Return |
|---|---|---|---|
| Currency | rate (C_{LOC}) | Return (BR_{LOC}) | (BR_{LOC} − C_{LOC}) |
| JPY | 0% | 4% | 4% |
| EUR | 3% | 5% | 2% |

The fixed income or hedged fixed income allocation 106 may further decomposed into various components that represent the investment strategies associated therewith. In one embodiment, the fixed income allocation is decomposed into at least one of a yield curve management strategy component 108, a sector allocation strategy component 110, and a security selection strategy component 112. This aspect of the present invention is particularly suited for fixed income manager that analyze and set active exposures towards yields of government bonds, sector spreads over government, and security specific spreads over sector. In this respect, the present model decomposes performance based on strategies that are familiar to asset managers and provide an intuitive measure of performance for managers to identify strengths and weaknesses in the investment process. In another embodiment, the return of each individual security of the investment portfolio is decomposed into the corresponding return components, in accordance with the following algorithm:

$${HBR}_{USD} = \underbrace{{HG}_{USD}}_{1} + \underbrace{( {HS}_{USD} - {HG}_{USD} )}_{2} + \underbrace{( {HBR}_{USD} - {HS}_{USD} )}_{3}$$

Where:
1=Hedged government bond return (in USD)
2=Hedged sector excess return (over government)
3=Hedged bond return over sector

The yield curve management strategy is generally achieved through a combination of strategies, including the active duration allocation, curve positioning, and market allocation strategies, and focuses on the active management at the global level of the exposure towards the hedged government bond return. The sector allocation strategy focuses on the exposure to the hedged sector excess return over government at the global level. This includes sector allocation across markets, across ratings, industries etc. Sector allocation is sometimes referred to as the “top-down” spread allocation. The security selection strategy focuses on the hedged bond return over sector where each security is evaluated with respect to its peers. For example, a bond issued by Ford in EUR will be compared with the BBB rated segment of the auto industry in the EUR market. The present model is flexible with regard to how the peers and sectors are defined, i.e., the investment process defines the terms. In the example illustrated in Table C, it can be seen that the BBB auto industry outperformed the government sector by 2.5%, however Ford underperformed its peers by 0.5%.

TABLE C

| Hedged Ford | Hedged Govt. | Hedged BBB Auto |
|---|---|---|
| Return (HBR_{USD}) | Return (HG_{USD}) | Return (HS_{USD}) |
| 6% | 4% | 6.5% |

Yield curve management strategies generally refer to strategies with regard to securities that are influenced by government bond yields and not only those that active in government bonds. Corporate bonds, for example, are not only exposed to sector and security specific spread changes, they are also exposed to the government bond yield changes. An increase of government interest rates negatively impacts the corporate bonds as well. In one embodiment, the return of the yield curve component is decomposed into implied yield changes 114 and accrued interest components 122. Implied yield changes generally refer to the performance attributed to strategies, such as the duration, market allocation, and curve position strategies.

In order to correctly attribute the performance to particular strategies, the performance, e.g., of hedged government bonds, is further decomposed into the drivers along which the strategies are set. In one embodiment, the performance is further decomposed into the duration 116, curve positioning 118, and market allocation 120 strategy components. Duration, for example, a key dimension of fixed income strategy, is driven by interest rate or yield changes rather than bond returns. The implied yield change with respect to duration may be defined with the following algorithm:

$${HG}_{USD} = \frac{{HG}_{USD} - Ai}{D} \times D + Ai ≡ \underbrace{- dy \times D}_{price return} + {\underbrace{Ai}}_{{accrued}_{interest}}$$

Where:
Ai=accrued interest hedged over the period
D=modified/effective duration of the bond
dy=implied hedged interest rate change

Decomposition along the drivers of the particular investment strategies allows for the transformation of the respective drivers into accrued interests and yield change equivalents on which fixed income managers set duration allocations. Implied yield change as described herein reverses and extends the relationship used by fixed income managers, where returns are approximated by the product of (minus) duration and yield changes. Implied yield changes may also be inferred from the actual performance, which eliminates residuals that arise when actual yield changes are used. When the returns are calculated over short period of time the numerical difference is negligibly small.

The yield changes, e.g., attributed to yield curve management component 108, may be decomposed similar to a multi-step investment process, which generally entails setting the duration allocation for the overall portfolio compared to the benchmark, allocating active durations across local markets with the constraint of unchanged overall portfolio duration, and setting curve position within each local market without modifying the active duration in each market. In one embodiment, the decomposition is illustrated with the following algorithm.

$$dy = \underbrace{{dy}_{global}}_{{absolute}_{change} } + \underbrace{( {dy}_{local} - {dy}_{global} )}_{{local market}_{relative change} } + \underbrace{( dy - {dy}_{local} )}_{{curve relative}_{change} }$$

Where:
dy_{global}=global duration weighted average of the interest rate change

dy_{local}=duration weighted average of the interest rate change in the local market where the bond is issued

TABLE D

| 2 year US Treasury | | US Market | Global Yield |
|---|---|---|---|
| Yield Change (dy) | | Change (dy_{local}) | Change (dy_{global}) |
| | +2% | +1.5% | +2.5% |

In the example illustrated in Table D, the 2-year Treasury yield increase of 2% is decomposed into a global yield increase of 2.5%, a relative contraction of US yields of 1% and a widening of 0.5% of the 2-year bond with respect to the US market. In this example, all bonds are exposed to the global yield changes, all US bonds to the US market yield change, and all 2-year US bonds to the 2-year US Treasury yield change, where the exposure is measured in terms of duration.

By aggregating the portfolio holdings, one can obtain the portfolio exposure for the different interest rate changes attributed to the applicable investment strategies. Given that active portfolio managers set portfolio strategies with respect to a defined benchmark rather than in absolute terms, in one embodiment, the portfolio relative exposures are compared to the benchmark, or active exposures, that are measured as weighted duration deviations (WDD). In this instance, the overall active duration of the portfolio is the exposure towards the global interest rate changes, which in the above example is illustrated by yields having moved up 2.5%.

The active duration across local market, or simply market allocation, exploits relative yield changes of one market compared to the global yield move (US yields contracted 1%), and the curve positioning within a local market targets yield curve shape changed within each market (2 year US yields widened 0.5%). The accrued interest return or active coupon is shown below separately since it cannot be precisely attributed to a specific strategy. A bullet curve positioning as well as a long duration strategy can generate positive active coupon return.

Through the active management of the overall duration of the portfolio compared to the benchmark (D^{p}−D^{b}=WDD) an asset manager seeks to exploit the movement of interest rates. In single currency portfolios the relevant movement is that of government yields in that local market and in global portfolios the relevant interest rate movements at the global level. The corresponding active duration performance attribution (AD) may be defined with the following algorithm:
AD=−(D^{p}−D^{b})×dy_{global}=−WDD×dy_{global}

Referring to the example illustrated in the Yield Curve Management Tables E-F provided in Appendix 2, the benchmark has a duration of 5 years and the portfolio 5.58 year. With a global yield increase of 2.5% the performance attributed to the active duration management is -1.45% (=-0.58 x 2.5%).

Asset managers also seek to take advantage of relative interest rate movements across local markets by reallocating WDD from markets where yields are expected to rise relative to the other markets in favor of the markets where yields are expected to fall. The attribution of this duration allocation across local markets, or simply market allocation (MA) may be defined with the following algorithm:

$$MA = - {\sum }_{local} {WDD}_{local} \times ( {dy}_{local} - {dy}_{glocal} )$$

Referring back to our previous example, the yields in the US market increased by 1% less than the global yields (US bonds outperformed), whereas in Europe by 1% more. Underexposing the portfolio to Euro yields (2.0 years compared to 2.5 years of the benchmark) and, respectively, overexposing the US market (WDD +1.09y) generated a positive attribution from market allocation of 1.58% (=−[(−0.5)×(1%)+(1.09)×(−1%)]). The relationship that makes the portfolio unexposed to market allocation is provided in below.

The performance due to non-parallel movement of the yield curve within the local markets, i.e. different interest rate changes depending on the maturity of the bonds, is captured by the curve positioning attribution (CP). The CP attribution considers the average movement of the local market interest rates. For this model we assume that the asset manager generally sets the curve positioning strategy within a local market, i.e. distributes WDD along the maturity curve, only after the total WDD for local market has been fixed. In other words, a duration allocation in the local market is considered first and a duration neutral curve position in that particular market is successively sets. In one embodiment CP is determined with the following algorithm:

$$CP = {\sum }_{local} [ \underbrace{- {\sum }_{mat} {WDD}_{local , mat} \times ( {dy}_{local , mat} - {dy}_{local} )}_{{curve positioning attribution within}_{a specific local market} } ]$$

Referring back to our previous example, the yields in the US market rose by 1.5% on average, and at the same time the curve flattened: the 2y yields increased by 2%, the 10y by 1.5%, and the 30y by 1.1%. The active market duration of 1.09 years follows a barbell strategy where the short maturity is overexposed by 0.1y, the 10 years maturity by −0.41y and the long maturity by +1.4y. The performance attributed to this strategy is +0.51% (=−[0.1×(2%−1.5%)+(−0.41)×(1.5%−1.5%)+1.4×(1.1%−1.5%)]. Similarly, the attribution to the curve in Europe is +0.16% for a total of 0.68% for the entire portfolio.

The described decomposition, based on simple yield changes (hedged) rather than yield changes with respect to forward interest rates (hedged), leaves unallocated the performance due to the (hedged) accrued interests. Since this cannot be unequivocally attributed to one of the strategies above it may be kept separate. In one embodiment, the attribution to the accrued interest or the active coupon allocation (AC) is defined with the following algorithm:

$$AC = {\sum }_{local} {\sum }_{mat} ( {w}_{local , mat}^{p} - {w}_{local , mat}^{b} ) \times ( {Ai}_{local , mat} - {Ai}_{global} )$$

Where:
W^{p}_{local,mat} is the portfolio weight in a specific local market and maturity

Referring back to our previous example, the coupons (hedged) in Europe are higher than in the US and in both market increasing with maturity. The underweight in Europe (overweight in the US) penalize the return attributed to the accrued interests. In the US the accrued interests of the three bonds are below the global average, whereas the Europe bonds above it. The performance attribution is of −0.12% (=[5% ×(1%−1.8%)−5% ×(1.3%−1.8%)+. . . +0% ×(3.5%−1.8%)]). In praxis, the attribution to accrued interests of the active allocation is usually rather small. Note, the coupon allocation refers to the government bond component only; the additional coupon of corporate bonds or other sectors'bonds is attributed to the sector allocation.

The hedged sector excess return (HEr) may generally be defined with the following algorithm:
HEr_{USD}=(HS_{USD}−HG_{USD})
HEr measures the additional return of a sector in a specific market and maturity over the corresponding government bond. This incorporates the additional coupon and roll down of the non-government bonds as well as any loss/gains incurred by the sector due to constituent downgrades, upgrades, or defaults. In one embodiment, we do not decompose the return due to spread curve reshaping or market allocation within a specific sector, and, therefore, we can directly attribute the performance of active strategies based on the simultaneous comparison of all sectors across market and along the maturity curve. Consequently, the notion of implied spread change and corresponding exposure, the spread duration, is not necessary for the model.

In one embodiment, the sector allocation (SA) attribution is defined with the following algorithm:

$$SA = {\sum }_{local} {\sum }_{mat} {\sum }_{sect} ( {w}_{local , mat , sect}^{p} - {w}_{local , mat , sect}^{b} ) \times ( {HEr}_{local , mat , sect} - {HEr}_{global} )$$

In one embodiment, for the purpose of computing the SA attribution, each individual sector excess return is compared to the global average sector excess return.

Referring to the example illustrated in the Sector Allocation Table G provided in Appendix 2, the corporate sector in the US outperformed the government bonds (duration adjusted) by 40 bp whereas the Euro corporate sector return 60 bp more than the Euro government. The government sector underperformed the global average sector return by 19 bp (=0% government excess return by definition global average): the US and Euro corporates outperformed the average by 21 bp and 14 bp, respectively. Underweighting the US government by 15% added 3 bp (=−15% ×(0%−0.19%)) and overweighting the US corporate 2 bp. The overall performance due to the sector allocation is 4 bp. In this example, the sectors are defined very broadly. It is understood that the sectors may be defined much more narrowly, e.g., to avoid that security selection attribution captured performance that should be allocated to the sector allocation.

With regard to the sector allocation, in one embodiment, the peers to which a bond is compared are other bonds with the same maturity, in the same sector, and local market. Overweighting or underweighting bonds that outperform their peers results in a positive or negative attribution, respectively. Note the performance of bonds is not compared with respect to the Libor, otherwise, the sector return component would be count twice. In one embodiment, the security selection (SS) attribution is defined with the following algorithm:

$$SS = {\sum }_{local} {\sum }_{mat} {\sum }_{sect} {\sum }_{sec} ( {w}_{local , mat , sect , sec}^{p} - {w}_{local , mat , sect , sec}^{b} ) \times ( {HEr}_{local , mat , sect , sec} - {Her}_{local , mat , sect} )$$

Referring to the example illustrated in the Security Selection Table H provided in Appendix 2, the bonds in the US corporate sectors have different returns compared to their sector. Corp A outperformed its peers by 40 bp and Corp B underperformed by 20 bp. Active weight to government bonds or Euro Corp does not result in any attribution because the bonds in these sectors performed like the sector itself. The 10% overweight in US Corp A added 4 bp (=10% ×(2.8%−2.4%)), while the underweight in the underperforming US Corp B bond added 1 bp. The overall security selection attribution is +5 bp.

As noted above, the currency return (CR) may include both the rate of change of the reference currency exchange rate relative to the local currency (FX_{ref-curr}) and the premium or discount embedded in the forward currency market (f_{ref-curr}), as shown in the following algorithm:
CR_{curr}=FX_{ref-curr}+f_{ref-curr}
In one embodiment, the currency attribution (CA) is then based on the relative return of a specific currency compared to the average benchmark currency return as shown in the following algorithm:

$$CA = {\sum }_{curr} ( {w}_{curr}^{p} - {w}_{curr}^{b} ) \times ( {CR}_{curr} - {CR}_{global} )$$

The currency weight is generally the percentage sum of the exposure of all instruments is a specific currency (bonds, currency derivatives, cash, etc).

Referring to the example illustrated in the Currency Allocation Table I provided in Appendix 2, the Euro appreciated by 2% compared to the USD and 2.5% compared to the currency forwards. The base currency USD (0% performance by definition) underperformed the benchmark currency return by 1.13%, while the Euro outperformed it by 1.37%. The attribution of the 5% underweight in USD is +6 bp (=−5% x (−1.13%)) while the Euro 5% overweight +7 bp (=5% ×1.37%), for a total currency attribution of 13 bp.

According to the methodology illustrated herein, the performance attribution model (PA) for the overall active strategy is, in one embodiment, the sum of the currency, coupon, duration, market allocation, curve positioning, sector allocation, and security selection allocations, as illustrated in the following algorithm:

$$PA = CA ⇒ {\sum }_{curr} ( {w}_{curr}^{p} - {w}_{curr}^{b} ) \times ( {CEff}_{curr} - {CEff}_{global} ) + AC ⇒ {\sum }_{local} {\sum }_{mat} ( {w}_{local , mat}^{p} - {w}_{local , mat}^{b} ) \times ( {Ai}_{local , mat} - {Ai}_{global} ) + AD ⇒ - WDD \times {dy}_{global} + MA ⇒ - {\sum }_{mkt} {WDD}_{local} \times ( {dy}_{local} - {dy}_{global} ) + CP ⇒ {\sum }_{local} [ - {\sum }_{mat} {WDD}_{local , mat} \times ( {dy}_{local , mat} - {dy}_{local} ) ] + SA ⇒ {\sum }_{local} {\sum }_{mat} {\sum }_{sect} ( {w}_{local , mat , sect}^{p} - {w}_{local , mat , sect}^{b} ) \times ( {HEr}_{local , mat , sect} - {HEr}_{global} ) + SS ⇒ {\sum }_{local} {\sum }_{mat} {\sum }_{sect} {\sum }_{sec} ( {w}_{local , mat , sect , sec}^{p} - {w}_{local , mat , sect , sec}^{b} ) \times ( {HEr}_{local , mat , sect , sec} - {HEr}_{local , mat , sect} )$$

This allocation model presented herein expands and deepens the performance attribution measurement of fixed income portfolios. In one embodiment, the model separates the currency attribution from the fixed income one avoiding arbitrage possibilities when attributing the performance to the two asset classes. In another embodiment, the model allows a deep analysis of the performance of bond portfolios along the different strategy dimensions, of which fixed income managers are familiar. The implied yield changes and spread excess returns are used as performance drivers rather than total returns, allowing a correct separation of return due to the duration management, sector allocation, and security selection.

With regard to global yield curve management, the movement of interest rate curves is, in one embodiment, decomposed into an absolute change of yields and two relative movements: across markets and along the maturity curves. This allows one to separately attribute the performance to the active duration, market allocation and curve positioning strategies. With regard to the performance arising from the management of the spread component of the non-government bonds, the return due to the “top-down” sector allocation is clearly separated from the “bottom-up” security selection, allowing an unbiased attribution to these two distinct strategies.

With regard to neutral allocation, it is assumed that the following relationship applies:

$$\frac{{w}_{local}^{p} {D}_{local}^{P}}{{w}_{local}^{b} {D}_{local}^{b}} = \frac{{\sum }_{loc} {w}_{local}^{p} {D}_{local}^{p}}{{\sum }_{loc} {w}_{local}^{b} {D}_{local}^{b}}$$

This means that portfolio contribution to duration of each market has to be proportional to the benchmark contribution, where the proportionality factor is the ratio of portfolio and benchmark duration (duration factor). This relates the neutral allocation not only to the active duration (portfolio-benchmark) but also to the benchmark structure. With regard to the examples set forth in Appendix 2, the exposure in each market would be of 2.79 years (with the same total duration of 5.58 years). The curve positioning neutral allocation is constrained by the active duration in that market, which applies when:

$$\frac{{w}_{local , mat}^{p} {D}_{local , mat}}{{w}_{local , mat}^{b} {D}_{local , mat}} = \frac{{\sum }_{mat} {w}_{local , mat}^{p} {D}_{local , mat}}{{\sum }_{mat} {w}_{local , mat}^{b} {D}_{local , mat}}$$

Note that these portfolios can require leveraged positions. In the examples of Appendix 2, the exposure along the US curve would be 0.82, 1.76 and 1 year for the 2, 10 and 30 years maturities, respectively (with the same market exposure of 3.59 years).

Although the invention has been described herein as a methodology or model, it is understood that the product of the model, i.e., the performance attributions, may be used in various ways. For instance, the performance attributions may be used to identify outperforming or underperforming investment strategies. Granular feedback may be provided so that managers or investors may improve parts of the investment process or strategy that contributed to the overall performance. Moreover, the attributions may be used to identify asset managers that demonstrate superior or inferior skills with regard to particular strategies, which improves accountability for those responsible for particular strategies.

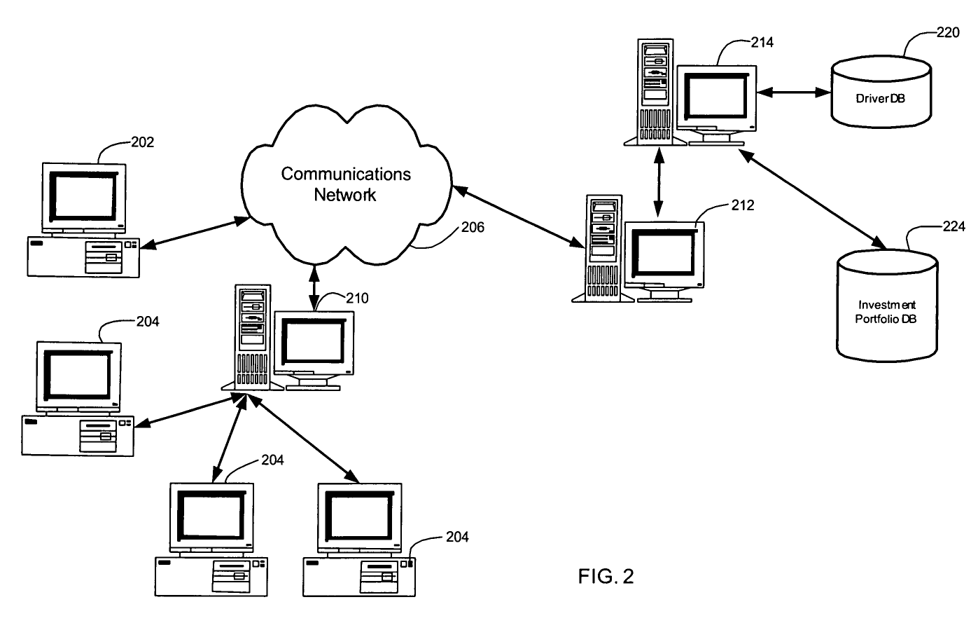

Referring to FIG. 2, a system for decomposing the performance of an investment portfolio into components that correspond to the performance attributed to particular investment strategies, as described herein includes at least one computing device 202, 204, which has software associated therewith which adopts the device 202 to decompose or allocate the performance associated with an investment portfolio as described herein. In one embodiment, the computing device 204 is connected over a communication network 206 to at least one server computer, such as proxy server 212, and/or an application server or servers 214, or any other type of host computer, having at least one database associated therewith, such as a return drivers database 220, an investment portfolio database 224. The computing devices 204 may further be connected to the servers 212, 214 though a proxy server 210. The host computer preferably includes therein software or computer programming that when executed computes the performance attributed to relevant investment strategies applied or applicable to the investment portfolio in accordance with the attribution model discussed noted above.

The communications network 206 is any suitable communications link, such as a local area network (LAN), wide area network (WAN), the Internet, a wireless network, or any combinations thereof. A computing device 202, 204 is generally a multipurpose computer having a processor and memory that is capable of communicating with the server computers 210, 212, 214 and also capable of displaying information received there from. A computing device may therefore be a personal computer (PC), special purpose computer, a workstation, a wireless device, such as personal digital assistants (PDA), cellular phones, two-way pagers, etc. The computing device 202 for instance, may be a terminal for use by an asset manager and the computing device 204 may be a terminal of a plurality of terminals for similar use in an office setting. The investment portfolio database 224 generally includes therein information or data regarding at least one portfolio, such as securities held therein, cost basis, etc., and the return drivers database 220 includes information with regard to the factors that drive the returns in accordance with the particular investment strategies, such as government yields or changes therein, etc.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

### Appendix 1: Definitions of Terms Used Herein

Implied Change in Yield (hedged)

Global implied yield change (duration weighted average):

$${dy}_{global} = \frac{{\sum }_{local} {\sum }_{mat} {w}_{local , mat}^{b} {D}_{local , mat} \times {dy}_{local}}{{\sum }_{local} {\sum }_{mat} {w}_{local , mat}^{b} {D}_{local , mat}}$$

Total weighted duration deviation:

$$WDD = {\sum }_{local} {WDD}_{local}$$

Local market implied yield change:

$${dy}_{local} = \frac{{\sum }_{mat} {w}_{local , mat}^{b} {D}_{local , mat} \times {dy}_{local , mat}}{{\sum }_{mat} {w}_{local , mat}^{b} {D}_{local , mat}}$$

Local market weighted duration deviation:

$${WDD}_{local} = {\sum }_{mat} ( {w}_{local , mat}^{p} {D}_{local , mat} - {w}_{local , mat}^{b} {D}_{local , mat} )$$

Implied yield change at a specific maturity and local market:

$${dy}_{local , mat} = - \frac{{HG}_{local , mat} - {Ai}_{local , mat}}{{D}_{local , mat}}$$

The weighted duration deviation at a specific maturity in a local market:
WDD_{local,mat}=W^{p}_{local,mat}D_{local,mat}−W^{b}local,matD_{local,mat}

With:

$${w}_{local , mat}^{b} {D}_{local , mat} = {\sum }_{sect} {w}_{local , mat , sect}^{b} {D}_{local , mat}$$

$$\text{And:}$$

$${w}_{local , mat}^{b} = {\sum }_{sect} {w}_{local , mat , sect}^{b}$$

$${w}_{local , mat , sect}^{b} = {\sum }_{sec} {w}_{local , mat , sect , sec}^{b}$$

Accrued Interest (Hedged)

Global accrued interest (weighted average):

$${Ai}_{global} = {\sum }_{local} {\sum }_{mat} {w}_{local , mat}^{b} \times {Ai}_{local , mat}$$

Where Ai_{local,mat} refers to the hedged accrued interests of the local government bond with a specific maturity.

Excess Return

Global (hedged) sector excess return (weighted average):

$${HEr}_{global} = {\sum }_{local} {\sum }_{mat} {\sum }_{sect} {w}_{local , mat , sect}^{b} \times {HEr}_{local , mat , sect}$$

Sector excess return in a specific local market and maturity:

$${HEr}_{local , mat , sect} = \frac{{\sum }_{sec} {w}_{local , mat , sect , sec}^{b} \times {HEr}_{local , mat , sect , sec}}{{\sum }_{sec} {w}_{local , mat , sect , sec}^{b}}$$

Where:
HEr_{local,mat,sect,sec}=HBR_{local,mat,sect,sec}−HG_{local,mat}

The hedged return (HBR) of a security (sec) in a specific sector (sect) and maturity (mat) in a local market (local) in excess of the local government with the same maturity.

Currency Return

Global currency return:

$${CR}_{global} = {\sum }_{curr} {w}_{curr}^{b} \times {CR}_{curr}$$

The benchmark currency return measured in a reference currency.

Where:
CR_{curr}=FX_{ref-loc}+f_{loc-ref}
FX_{ref-loc} is the rate of change of the reference currency exchange rate relative to the local currency and f_{loc-ref} is the forward premium or discount between the two currencies.

### Appendix 2: Attribution Examples

Yield Curve Management

Positions and Returns:

TABLE E

| | Market | | | | | | | | | | Active | |
|---|---|---|---|---|---|---|---|---|---|---|---|---|
| | | | Hedged Performance | | | Impl. | Benchmark | | Portfolio | | Allocation | |
| | Maturity | Duration | Price | Accr. Inter. | Total | Yield Ch | Weights | CTD | Weights | CTD | Weight | WDD |
| USD | 2 | 1.9 | −3.80% | 1.00% | −2.80% | 2.00% | 30% | 0.57 | 35% | 0.67 | 5% | 0.10 |
| | 10 | 8.2 | −12.30% | 1.30% | −11.00% | 1.50% | 15% | 1.23 | 10% | 0.82 | −5% | −0.41 |
| | 30 | 14 | −15.40% | 1.50% | −13.90% | 1.10% | 5% | 0.7 | 15% | 2.1 | 10% | 1.40 |
| USD Total | | | | | −6.37% | 1.50% | 50% | 2.5 | 60%. | 3.59 | 10% | 1.09 |
| EUR | 2 | 1.9 | −5.70% | 2.00% | −3.70% | 3.00% | 30% | 0.57 | 25% | 0.475 | −5% | −0.10 |
| | 10 | 8.2 | −32.80% | 3.00% | −29.80% | 4.00% | 15% | 1.23 | 10% | 0.82 | −5% | −0.41 |
| | 30 | 14 | −42.00% | 3.50% | −38.50% | 3.00% | 5% | 0.7 | 5% | 0.7 | 0% | 0.00 |
| EUR Total | | | | | −15.01% | 3.49% | 50% | 2.5 | 40% | 2.00 | −10% | −0.50 |
| Total | | | −12.49% | 1.80% | −10.69% | 2.50% | 100% | 5 | 100% | 5.58 | 0% | 0.58 |

total market returns and yield changes based on benchmark composition

Performance attribution:

TABLE F

| | | Attribution | | | |
|---|---|---|---|---|---|
| | Maturity | AD | MA | CP | AI |
| USD | 2 | −0.24% | 0.09% | −0.05% | −0.04% |
| | 10 | 1.02% | −0.41% | 0.00% | 0.02% |
| | 30 | −3.50% | 1.39% | 0.56% | −0.03% |
| USD Total | | | | 0.51% | |
| EUR | 2 | 0.24% | 0.09% | −0.05% | −0.01% |
| | 10 | 1.02% | 0.41% | 0.21% | −0.06% |
| | 30 | 0.00% | 0.00% | 0.00% | 0.00% |
| EUR Total | | | | 0.16% | |
| Total | | −1.45% | 1.58% | 0.68% | −0.12% |

Sector Allocation

The sector allocation, the security selection and currency examples are based on the same data.

Positions, returns and performance attribution:

TABLE G

| | | Hedged Returns | | Benchmark | Portfolio | Active | Attribution |
|---|---|---|---|---|---|---|---|
| | | Total | Excess | weight | weight | weight | SA |
| USD | Govt | 2.0% | 0.0% | 30% | 15% | −15% | 0.03% |
| | Corporate | 2.4% | 0.4% | 25% | 35% | 10% | 0.02% |
| EUR | Govt | 1.6% | 0.0% | 30% | 35% | 5% | −0.01% |
| | Corporate | 2.2% | 0.6% | 15% | 15% | 0% | 0.00% |
| Total | | | 0.19% | 100% | 100% | 0% | 0.04% |

all sectors same duration

Security Selection

Positions, returns and performance attribution:

TABLE H

| | | Hedged Returns | | Benchmark | Portfolio | Active | Attribution |
|---|---|---|---|---|---|---|---|
| | | Total | Excess | weight | weight | weight | SS |
| USD | Govt | 2.0% | 0.0% | 30% | 15% | −15% | 0.00% |
| | Corp A | 2.8% | 0.4% | 5% | 15% | 10% | 0.04% |
| | Corp B | 2.2% | −0.2% | 10% | 5% | −5% | 0.01% |
| | Corp C | 2.4% | 0.0% | 10% | 15% | 5% | 0.00% |
| Euro | Govt | 1.6% | 0.0% | 30% | 35% | 5% | 0.00% |
| | Corp A | 2.2% | 0.0% | 10% | 5% | −5% | 0.00% |
| | Corp B | 2.2% | 0.0% | 5% | 10% | 5% | 0.00% |
| Total | | | 0.00% | 100% | 100% | 0% | 0.05% |

Currency Allocation

Positions, returns and performance attribution:

TABLE I

| | Currency Return | | | Benchmark | Portfolio | Active | Attribution |
|---|---|---|---|---|---|---|---|
| | FX | f (premium) | Total | weight | weight | weight | SA |
| USD | 0.0% | 0.0% | 0.0% | 55% | 50% | −5% | 0.06% |
| EUR | 2.0% | 0.5% | 2.5% | 45% | 50% | 5% | 0.07% |
| Total | | | 1.13% | 100% | 100% | 0% | 0.13% |

base currency USD

### Appendix 3: Investment Strategy Drivers

Duration Management

Performance driver: interest rate change (local or global)
Example: German government bond yield increased by 0.50%

Exposure: (modified) duration
Example: 5.5 years, 0.5 years longer than the benchmark
   Curve Positioning

Performance driver: yield curve shape change
Example: German short maturity yield increased by 0.2% and long dropped by 0.2%

Exposure: weighted duration (market weight x duration) at a specific maturity

Market Allocation

Performance driver: change of yield difference between markets
Example: Spread between German and US yields dropped by 0.3%

Exposure: weighted duration

Sector Allocation

Performance driver: sector spread change
Example: The auto BBB bond yield over government dropped by 0.10%

Exposure: spread duration

Security Selection

Performance driver: security specific spread change over its sector
Example: 5 year Ford spread over auto BBB dropped by 0.10%

Exposure: spread duration

Currency Allocation

Performance driver: adjusted foreign exchange rate changes
Exposure: total currency weight

1. A method for attributing investment portfolio performance comprising:
identifying at least one fixed income security that contributes to the performance of an investment portfolio; and
decomposing the performance of the identified fixed income security into at least one component that corresponds to the performance attributed to at least one investment strategy that contributes to the performance of the identified fixed income security.

2. The method of claim 1, wherein the at least one component comprises a fixed income allocation component and a currency allocation component, and wherein the currency allocation component comprises a return attributed to strategies associated with currencies, and the fixed income allocation component comprises a return attributed to fixed income securities.

3. The method of claim 2, wherein the return attributed to the fixed income allocation component is a hedged return.

4. The method of claim 2, comprising decomposing the fixed income component into at least one component that corresponds to an investment strategy associated with fixed income security asset management.

5. The method of claim 2, comprising decomposing the fixed income allocation component into at least one of:
a yield curve management strategy component,
a sector allocation strategy component, and
a security selection strategy component.

6. The method of claim 2, comprising decomposing the fixed income allocation component into at least one of:
a duration allocation strategy component,
a curve positioning strategy component,
a market allocation component,
a sector allocation strategy component, and
a security selection strategy component.

7. The method of claim 2, comprising decomposing the fixed income allocation component into at least one component that corresponds to a driver along which the investment strategy is set.

8. The method of claim 2, comprising decomposing the fixed income allocation component into at least one strategy driven by interest rate or yield changes.

9. The method of claim 2, comprising decomposing the fixed income allocation component is into at least one of:
a duration allocation strategy component,
a curve positioning strategy component, and
a market allocation strategy component.

10. A method for attributing investment portfolio performance comprising:
identifying at least one fixed income security that contributes to the performance of an investment portfolio; and
decomposing the performance of the identified fixed income security into at least one component that corresponds to the performance attributed to at least one investment strategy that contributes to the performance of the identified fixed income security, the investment strategy selected from a group consisting of:
a currency allocation component,
a duration allocation strategy component,
a curve positioning strategy component,
a market allocation component,
a sector allocation strategy component, and
a security selection strategy component.

11. A system for attributing investment portfolio performance comprising at least one computing device having software associated therewith that when executed performs a method that comprises:
identifying at least one fixed income security that contributes to the performance of an investment portfolio; and
decomposing the performance of the identified fixed income security into at least one component that corresponds to the performance attributed to at least one investment strategy that contributes to the performance of the identified fixed income security.

12. The system of claim 11, wherein the at least one component comprises a fixed income allocation component and a currency allocation component, and wherein the currency allocation component comprises a return attributed to strategies associated with currencies, and the fixed income allocation component comprises a return attributed to fixed income securities.

13. The system of claim 12, wherein the return attributed to the fixed income allocation component is a hedged return.

14. The system of claim 12, wherein the method comprises comprising decomposing the fixed income component into at least one component that corresponds to an investment strategy associated with fixed income security asset management.

15. The system of claim 12, wherein the method comprises decomposing the fixed income allocation component into at least one of:
a yield curve management strategy component,
a sector allocation strategy component, and
a security selection strategy component.

16. The system of claim 12, wherein the method comprises decomposing the fixed income allocation component into at least one of:
a duration allocation strategy component,
a curve positioning strategy component,
a market allocation component,
a sector allocation strategy component, and
a security selection strategy component.

17. The system of claim 12, wherein the method comprises decomposing the fixed income allocation component into at least one component that corresponds to a driver along which the investment strategy is set.

18. The system of claim 12, wherein the method comprises comprising decomposing the fixed income allocation component into at least one strategy driven by interest rate or yield changes.

19. The system of claim 12, wherein the method comprises decomposing the fixed income allocation component is into at least one of:
a duration allocation strategy component,
a curve positioning strategy component, and
a market allocation strategy component.

20. A system for attributing investment portfolio performance comprising at least one computing device having software associated therewith that when executed performs a method that comprises:
identifying at least one fixed income security that contributes to the performance of an investment portfolio; and
decomposing the performance of the identified fixed income security into at least one component that corresponds to the performance attributed to at least one investment strategy that contributes to the performance of the identified fixed income security, the investment strategy selected from a group consisting of:
a currency allocation component,
a duration allocation strategy component,
a curve positioning strategy component,
a market allocation component,
a sector allocation strategy component, and
a security selection strategy component.
